(19) United States
(12) Patent Application Publication
(10) Pub. No.: US 2002/0128735 A1
(43) Pub. Date: Sep. 12, 2002

(54) Dynamic and extensible task guide

(76) Inventors: Parris C.M. Hawkins, Pleasanton, CA (US); Badri N. Krishnamurthy, Fremont, CA (US)

Correspondence Address: PATENT COUNSEL APPLIED MATERIALS, INC., Legal Affairs Department, P.O. Box 450A, Santa Clara, CA, 95052, US

(21) Appl. No.: 09/800,980

(22) Filed: Mar. 8, 2001

(51) Int. Cl. G05B 19/42

(52) U.S. Cl. 700/86

(57) ABSTRACT

An automated task guide system, method and medium for preventive maintenance and/or implementation of manufacturing activities in a manufacturing facility are described. At least some embodiments of the present invention envision a task guide software component configured to include a plurality of tasks to be performed manually or automatically. The plurality of tasks may include one or more optional tasks that are to be executed optionally, one or more floating tasks that are to be executed any time during the execution of the task guide, and one or more mandatory tasks that must be executed.

### FIELD OF THE INVENTION

The present invention relates to software task guides. More specifically, the present invention relates to a computer-implemented task guide system, method and medium that is capable of being extensible and dynamic, the task guide system, method and medium being configured to assist in the implementation of manufacturing activities and/or preventive maintenance in a manufacturing environment.

### BACKGROUND OF THE INVENTION

As machines and processes in most industries become increasingly complex, a need has arisen to carefully ensure that the various tasks that are required in, e.g., a factory setting, are accomplished so that a desired product of desired quality is produced. Thus, for technicians working in such factory settings, it is important that they make sure that certain items that need to be implemented in the course of manufacturing a product are, in fact, properly implemented, and at the appropriate time.

A general example of the above concept is as follows. For optimal operations of manufacturing machines used in complex manufacturing systems and processes (e.g., fabrication systems for microelectronic devices), the machines must be properly maintained and prepared. In order to achieve this goal, the machines undergo regular preventive maintenance activities such as check-ups, repairs, replacement of parts, refills of fluids, etc. The preventive maintenance activities usually include a sequence of steps to be completed by a maintenance technician. Proper adherence to these steps is often critical to ensure proper operation of these machines. Another aspect in the optimal operations of the manufacturing machines is that a manufacturing technician (through a sequence of steps) carefully ensures that the machines follow a sequence of manufacturing steps (e.g., for moving a batch of materials from one machine to another or depositing precisely defined amounts of specified materials on wafers). Thus, to assist technicians to perform preventive maintenance activities or activities those relating to manufacturing processes, the sequence of steps that need to be performed are often put into some type of list format such as a “task guide” (e.g., checklist) of steps or tasks.

The complexity associated with using conventional task guides to ensure that the appropriate tasks are implemented in a complex factory environment can be better appreciated by a discussion of an exemplary factory environment depicted by FIG. 1. Referring now to FIG. 1, this Figure illustrates an example of microelectronic device fabrication system (101) that includes assembly lines 102 and 110. Each assembly line includes manufacturing machines such as a number of etchers 103, 105, 111, 113 and layer depositors 107, 109, 115, 117. Fabrication system 101 also includes one or more controllers 119, 121. The letter “L” for etcher 105 in assembly line 1, “M” for layer depositor 109 in assembly line 1, “N” for etcher 113 in assembly line Q, “O” for layer depositors 117 in assembly line Q, “P” for controller 121 and “Q” for assembly line 110 represent different integer numbers to illustrate the utilization of any number of the designated items.

An etcher is a manufacturing machine configured to etch a layer or layers of a substrate during manufacture of microelectronic devices. Similarly, a layer depositor is a machine configured to deposit a layer or layers on a substrate during manufacture of electronic devices. Assembly line machines (e.g., etchers, depositors) and controllers include a computer or computer-like device that includes a processor, a read-only memory device and a random access memory.

Manufacturing facilities (e.g., the fabrication assembly lines as described above) require control and management computer software for proper operation thereof. An example of such software is the FAB 300 V. 1.0, from Consilium, Inc. (an Applied Materials company) of Mountain View, Calif. The FAB300 is an integrated suite of microelectronic device fabrication management software that controls and automates real-time operations of fabrication equipment, (e.g., fabrication system 101) including those using 300 mm wafers. The FAB300 is a component software based system that includes application components to coordinate and optimize materials, equipment, quality information, documents, scheduling, dispatching, yield and other elements of the computer-integrated manufacturing environment. FIG. 1 and the corresponding description above is provided to convey the complexity of manufacturing processes and their control and management software. It follows that performing preventive maintenance or manufacturing processes using task guides also have become complex in proportion with the overall complexity of the manufacturing processes. Accordingly, a task guide with tasks or steps printed on paper, as they have been practiced in conventional task guide methods, is inadequate and inefficient to be used in the complex manufacturing processes of today. For example, in today's factory environment, some tasks may require immediate actions or control a technician's actions in a way that is not possible by the use of a paper task guide. Hence, a simple paper copy of a task guide is inadequate to ensure that such tasks be carried out.

Task guides printed on paper are also inefficient because, in constantly changing manufacturing processes, the task guides are required to be updated frequently. This requires new task guides to be created, printed and distributed. Simply rendering paper copy task guides on computer is also inadequate and inefficient because many of the shortcomings of paper copy task guides are also not addressed therein.

### SUMMARY OF THE INVENTION

Accordingly, embodiments of the present invention provide a computer-implemented task guide system, method and medium to assist in the implementation of manufacturing activities and/or preventive maintenance in a manufacturing environment. At least some embodiments of the present invention include a task guide software component configured to include a plurality of tasks to be performed manually or automatically. The plurality of tasks may include one or more optional tasks that are to be executed optionally and one or more mandatory tasks that must be executed.

### BRIEF DESCRIPTION OF THE DRAWINGS

The detailed description of a preferred embodiments of the present invention showing various distinctive features may be best understood when the detailed description is read in reference to the appended drawing in which:

FIG. 1 is a schematic representation of exemplary manufacturing assembly lines;

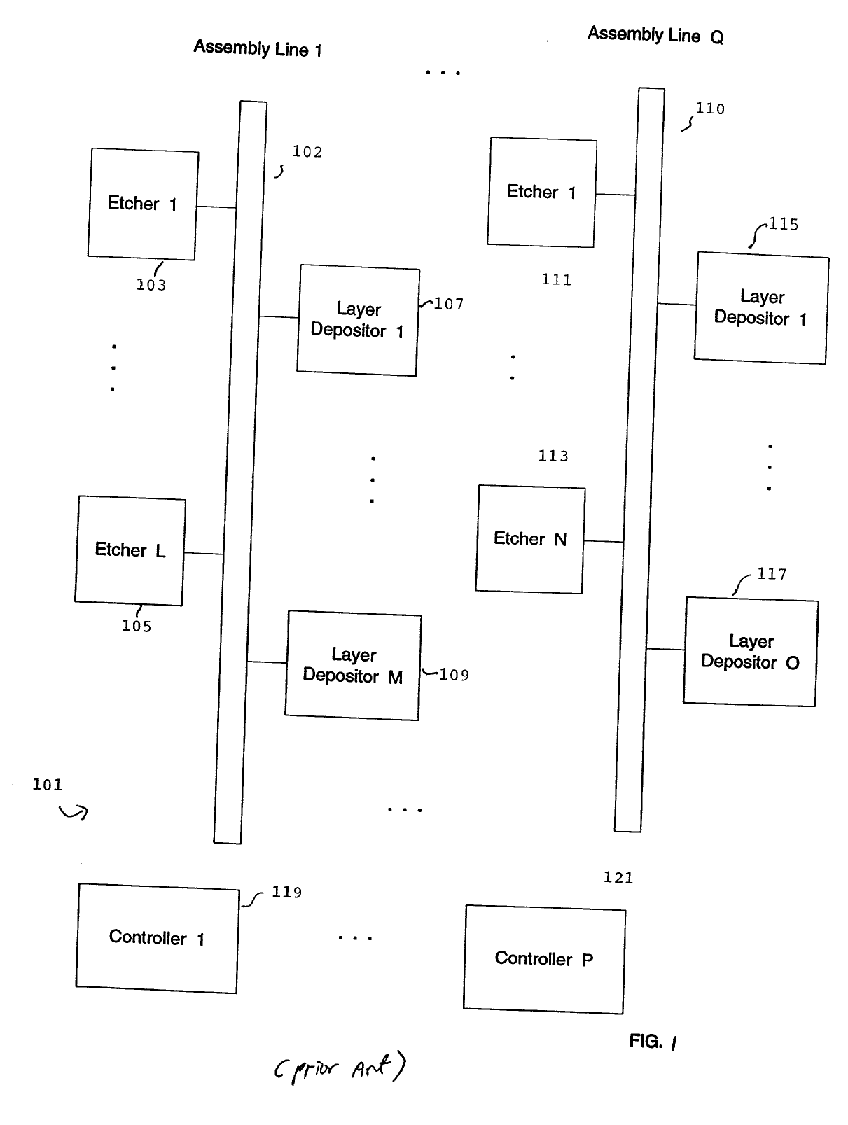

FIG. 2 is a schematic representation of certain aspects of FAB300;

FIG. 3 is a schematic representation of a task guide server according to at least some embodiments of the present invention;

FIG. 4 is a flow chart of the life cycle of a task guide according to at least some embodiments of the present invention;

FIG. 5 is a diagram illustrating a graphical user interface to be used by a modeler according to at least some embodiments of the present invention;

FIG. 6 is a schematic representation of the relationship among an object and two task guide sub-components according to at least some embodiments of the present invention;

FIG. 7 is a schematic representation of the server and its activities when a task guide is being processed according to at least some embodiments of the present invention;

FIG. 8 is a diagram illustrating a task guide process graphical user interface according to embodiments of the present invention;

FIG. 9 is a block diagram of a computer system that includes a server according to at least some embodiments of the present invention; and

FIG. 10 is a diagram illustrating a floppy disk that may store various portions of the software according to at least some embodiments of the present invention.

### DETAILED DESCRIPTION OF THE INVENTION

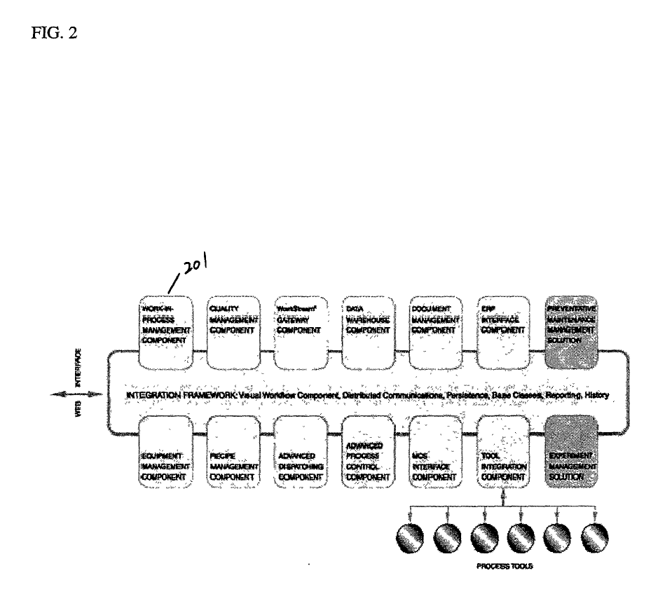

Embodiments of the present invention are described in the context of preventive maintenance activities and manufacturing processes of a manufacturing system such as microelectronic device fabrication assembly lines as described above and the FAB300 illustrated in FIG. 2. However, it should be noted that embodiments of the present invention may be used in other systems in which a task guide is required (e.g., an aircraft maintenance task guide, a preflight task guide, an automobile mechanic repair task guide, etc.). Moreover, it should be also noted that the words “step” and “task” are used interchangeably herein. Either word may refer to a manual step to be performed by a person or an automatic step that a computer or machine may perform.

In embodiments contemplated by the present invention, a task guide may refer to, depending upon the context in which it is referenced, a sequence of steps to be completed or to a task guide software component that embodies some or all aspects of embodiments of the present invention described herein. For instance, the task guide software component causes the sequence of the steps (to be completed) to be displayed on a computer monitor or some other information conveying device for a user (or an automated “expert” entity) to initiate or perform the steps. Furthermore, the task guide software component can be configured to operate in a software control system (e.g., FAB300) that includes a software framework and components such as the FAB300 framework and its components as shown in FIG. 2. It should be noted again that while some embodiments of the present invention are described in connection with the FAB300, the present invention is not limited to use with the FAB300. Embodiments of the present invention may be implemented and used in other component based software control systems. It should also be noted that a task guide operating as a standalone software package is also contemplated within embodiments of the present invention.

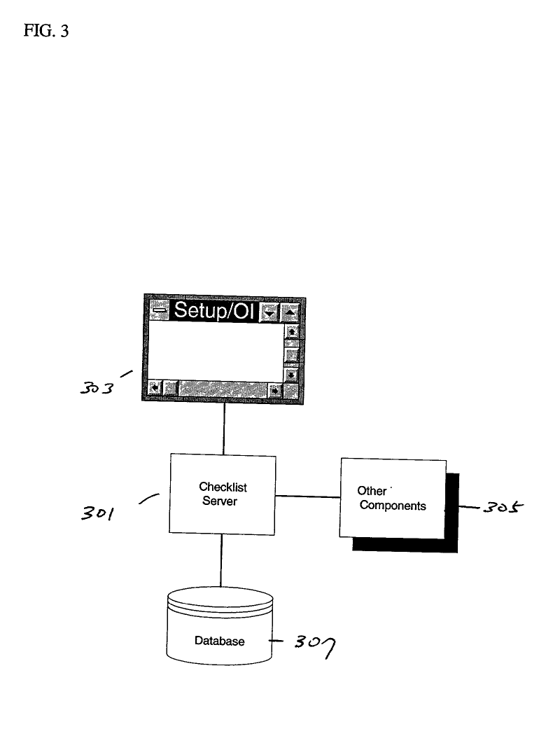

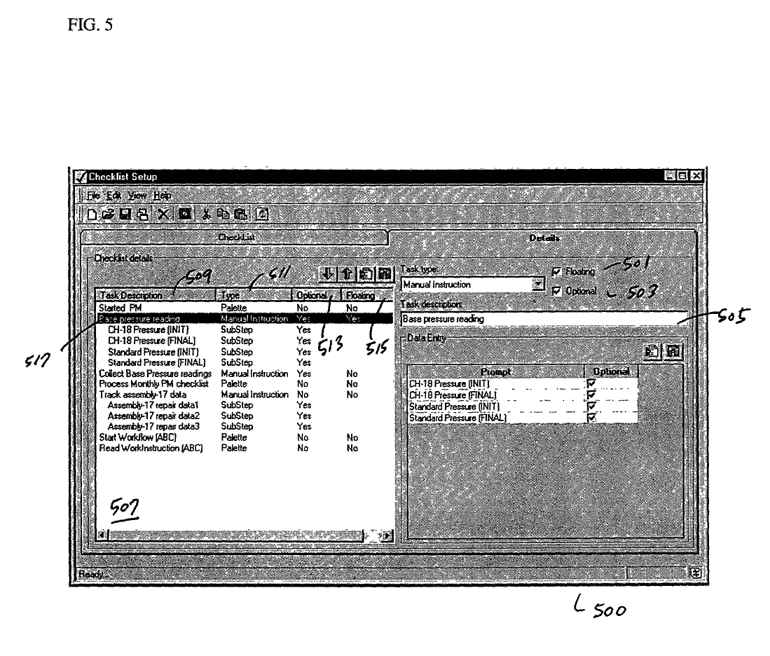

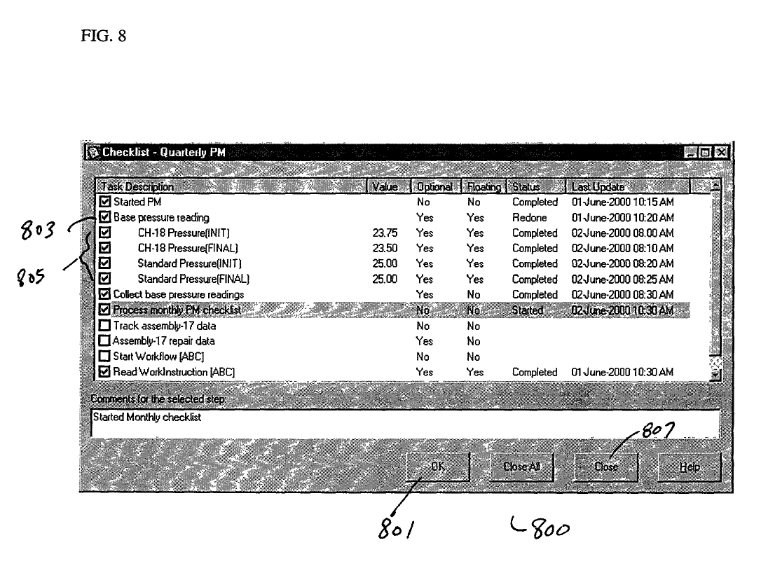

Environments and/or additional components used with at least some embodiments of the present invention are described in conjunction with FIG. 3. FIG. 3 illustrates a task guide server 301 (in which some or all of the task guide software component can reside or be a part of) is in communication with a GUI (Graphical User Interface) server 303, other components 305 of the software control system, and a database 307. Task Guide Server 301 can be a software component that provides services to model and process. GUI server 303 can be configured to control setting up and displaying GUIs (e.g., an editor or GUIs illustrated in FIGS. 5 and 8). Visual Basic can be used to implement various parts of GUI server 303, and Visual C++ can be used to implement various parts of server 301, although the present invention contemplates the use of any number of different programming languages.

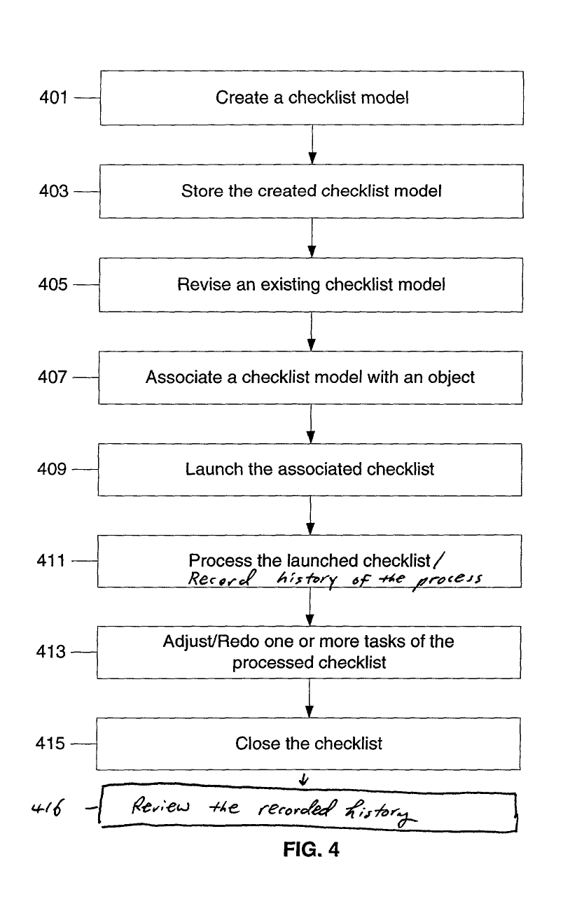

Now turning to FIG. 4, specific exemplary aspects of at least some embodiments of the present task guide invention are now described. More particularly, FIG. 4 depicts an exemplary methodology for the creation and usage (i.e., “lifecycle”) of contemplated aspects of the task guide invention. Referring now to the flowchart of FIG. 4, first, a task guide model (i.e., a task guide with predefined steps), is created (step 401) using GUIs (e.g., as shown in FIG. 5, to be described later). The created task guide model is then stored (step 403) in a database (e.g., database 307), possibly with other previously created task guide models. At least some embodiments of the present invention contemplate that the stored task guide may be revised (step 405) at a later time. A stored task guide model is then selected among the stored task guide models (e.g., in order to accomplish a given function), and the selected task guide model is associated with a software object in the software control system (step 407). A software object can represent or otherwise control any entity (in a manufacturing environment on which the present invention is based, and thus could, for example, be a software module that manages a manufacturing machine or a batch of materials). After the task guide model is associated with an object, an instance of the task guide model may be launched (step 409) when required (e.g., when maintenance is required). The launched task guide is then processed (step 411) according to the tasks included therein. As the tasks are processed, their history is recorded (e.g., processing time, any results, errors, etc.) One or more tasks in the processed task guide can be optionally adjusted or redone (step 413). After the completion of all the tasks in the task guide, the task guide is then closed (step 415). Subsequently, the history may be reviewed (step 416) for possible improvements. The above steps of FIG. 4 are described below in detail.

Before describing the individual steps of FIG. 4, some of the characteristics of the task guide software component in at least some embodiments of the present invention are described. The first of these characteristics is that it is configured to include manual steps as well as automated steps. The manual steps are to be conducted by a person (e.g., changing parts or manually collecting data). The automated steps are the steps that can be performed by a software object. More specifically, in the software control system, there can be a number of registered software objects that can each perform one or more specific tasks. For instance, a software object may be configured to check the status of a machine or trigger a manufacturing machine to run a self diagnostic procedure. Another exemplary software object may be configured to cause a material handling system (e.g., Work-in-progress Management Component 201 of the FAB 300 depicted in FIG. 2) to move a batch of materials from one machine to another. These software objects (with registered Application Program Interfaces, APIs, of the software control system) may then be used in the automated steps of the task guide. For example, when a user “checks” a box associated with an object (or aspect thereof), the object automatically performs the appropriate task. The second characteristic of the task guide is that any object of the system is also allowed to call a task guide model as part of its encapsulated processes.

Returning to FIG. 4, in a create a task guide model step 401, a user (hereinafter in the discussion of step 401, a modeler) may include (e.g., enter) any number of steps in the task guide model being modeled. In at least some embodiments of the present invention, one or more tasks may be defined as optional or floating steps. A floating step is a step that can be performed at anytime during the processing of the task guide (i.e., without regard to keeping to any sequence). An optional step is a step that can either be performed or skipped. This feature advantageously allows a number of tasks (e.g., one mandatory and one optional tasks) to be performed in parallel. In the task guide software component, the optional and floating steps can be tagged with flags such that these steps can be skipped while other mandatory steps (or those that must be performed in a sequential order, e.g., a descending order) are being processed.

As envisioned by at least some embodiments of the present invention, any registered automated service (accessed via an API) of an object may be selected and used in a step of a task guide. The task guide software component is configured so that a sub-step (e.g., a step within a step) or a sub-task guide (e.g., a task guide called by a step) can be included in a task guide model. Furthermore, it should be noted that manual instruction steps support sub-steps as well. These features allow cascading of task guides (e.g., a Weekly task guide to be part of a Monthly task guide and so on).

In addition, the modeler preferably defines and configures the task guide model to ensure that certain requirements are met. Specifically, the modeler ensures correct specification of parameters for any of the APIs called by a step within the task guide model being created. The modeler can also specify the description for one or more tasks and can specify opening and closing actions for the task guide.

In at least some embodiments of the present invention, it is envisioned that the task guide software component validates steps, sub-task guides and workflows included in the task guide model being created. More specifically, the following restrictions may be checked during this validation procedure: 1. one sub-task guide is to be processed at a time; 2. one workflow is to be launched from a task guide at a time; 3. a task guide preferably includes at least one step; 4. a workflow launched from a task guide preferably does not launch another task guide against the same associated object; 5. sub-task guides preferably belong to the same component; 6. a task guide model is preferably not deleted when any of its activities (execution object) are active. The above enumerated procedures are provided here only as examples for efficiently implementing embodiments of the present invention in the software control system, and are not in any way meant to be mandatory or otherwise impose limitations on the scope of the present invention.

Once a task guide model is completed, it is given a name and a version number and stored into a database (e.g., database 307). Preferably, after a version number is assigned to the task guide model, no changes may be introduced to the task guide model (unless new version number is assigned thereto).

A GUI 500 displaying an exemplary task guide model is illustrated in FIG. 5. GUI 500 shows various exemplary aspects that are related to the FAB300. It should again be understood, however, that GUI 500 is provided here only as an example, and that embodiments of the present invention are not limited to FAB300. Referring now to FIG. 5, GUI 500 is shown to include a number of features. For instance, whether a task is to be a floating and/or optional are selected by floating and optional select fields 501, 503, respectively. A description of each task can be entered into a task description field 505. A list of tasks to be accomplished are entered and maintained in a task guide window 507. Within task guide window 507, data display fields include task description 509, task type 511, optional 513 and floating 515 fields. Among the tasks listed, for instance, “base pressure reading” 517 is a manual instruction with a list of sub-steps for collecting (pressure) data related thereto. The “Palette” referenced in type field 511 refers to a GUI palette that displays APIs of some or all of registered objects in the software control system. The modeler is allowed select one or more objects from the GUI palette in creating the task guide.

As noted above, once the task guide model is completed, it is then stored into a database (step 403). Subsequently, a user (or some entity such as an object configured to call a task guide) selects a task guide from a number of task guide stored in the database (step 407). The selected task guide is then associated with an object.

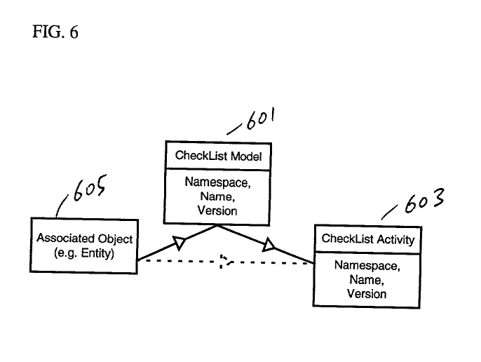

Now referring to FIG. 6, in order to provide the context in which the associating (step 407) takes place, at least some embodiments contemplated by the present invention envision that the task guide software component can include two sub-components that may be used independently or as part of servers for other components 305 (as indicated below) within the software control system. The first sub-component represents the setup and configuration interface of the task guide software component, and is referred to as a Task Guide Model component 601. The second sub-component represents the working instances (i.e., execution aspect) of the task guide software sub-component and is referred to as a Task Guide Activity component 603.

In at least some embodiments of the present invention, associating a Task Guide Model 601 with a software object 605 creates a reference to task guide model 601 from within object 605 so that it may instantiate (i.e., spawn an instance of) a Task Guide Activity 603. More specifically, a reference to Task Guide Model 601 is made within object 605 so that it may instantiate Task Guide Model 801 (i.e., launch it), thereby, for instance, displaying the task guide to a user for further processing. It should be noted that, in at least some embodiments of the present invention, two or more objects can be associated with one task guide.

Once a Task Guide Activity component 603 is instantiated, the task guide is said to have been launched (step 609). Alternatively, a task guide can be launched manually from within any component of the software control system or from within a workflow. A workflow is an overall automatic business process executed by the software control system on behalf of an object such as a tool.

When launched, information relating to Task Guide Activity 603 is generated. In particular, the generated information (which is, e.g., displayed to a user) may include part or all of a unique ID, the name of the instantiated Task Guide model, version number and activity ID of the launched (root) task guide. This generated information (which is envisioned to be automatically generated by at least some embodiments of the present invention) is then stored in the launching object 605.

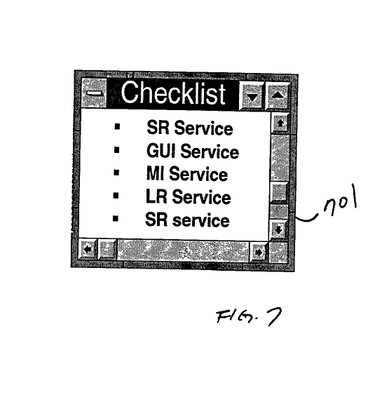

Now turning to describe the processing step 411, once the task guide is launched, the tasks included in the launched task guide are processed. As shown in FIG. 7, a task guide may include steps directed to the following list 701 of exemplary services: a short running (SR) service; a Graphical User Interface (GUI) service; a long running (LR) service; Manual Instruction (MI) service.

More specifically, an example of an “SR service” is a logging in event in the history of the object whose behalf the task guide is being processed (which, typically, is “short” in duration) without the use of a GUI. A “GUI service” displays GUIs, e.g., displaying a GUI directed to instructions on how to conduct preventive maintenance. An example of an “LR service” is calling a sub-task guide or a workflow that requires tracking the progress of the service over certain length of time (e.g., few seconds to minutes or longer). An example of an “MI service” is a cleaning job that may take one or more hours to be performed manually.

FIG. 8 illustrates a GUI 800 that shows an exemplary task guide being processed (step 611). More specifically, when a task guide is processed in accordance with this example, GUI 800 can be displayed on a display monitor and the cursor is placed on the first step. The cursor moves down as each step is checked off as completed by the user. Depending on how each of the steps is modeled, an action takes place for each listed step. Each step is preferably launched by typing a command or clicking on “OK” button 801. Short running tasks are executed immediately and the status of those tasks are refreshed accordingly. Long running, GUI or manual instruction steps cause a status of “Started” to be displayed until the task is completed. Manual instructions support multiple tasks, (e.g., data collection tasks where a user can enter data). For a manual step (e.g., “Base Pressure Reading” 803), the step may include sub-steps (see indented steps 805 under the “base pressure reading” step) to collect data for the prompts defined during modeling.

The listed steps are to be performed in the sequence as they are listed (e.g., modeled by a modeler) unless the steps are marked as floating or optional. A user would perform the tasks if they are manual tasks, or cause the tasks to be performed (by, e.g., checking the appropriate box), if they are automatic steps.

The task guide software component is configured such that a user may specify any one or more of the steps to be redone, or tag them as problem steps. The user is also allowed to enter comments for each step, which are written along with the history to the associated object. As noted above, the floating steps, if any, may be executed at any time in the process.

Once all the mandatory (non-optional) tasks in the task guide are complete, the task guide can be closed. Clicking on a “Close” button 807 will close the current task guide only if all mandatory steps are completed. The task guide software component may also validate to check if all mandatory steps have been completed in the root task guide and all sub-task guides. An error is raised if the validation fails. When a sub-task guide is completed, it needs to be closed to return control to the parent task guide. A task guide cannot be closed if it has a sub-task guide that is being processed. However, separate APIs may be provided for privileged users to close a task guide and its sub-task guides without any validation.

The completion of a task and the results thereof are automatically recorded for a running log or GUI services while the user is required to manually record any change in status for a manual instruction step. In particular, every time a task guide is processed, an activity record is created associating the object, and history is recorded to the task guide and the associated object. A unique activity ID is used to internally tie the object to the activity history. During the process, users are allowed to see the status of every step. Even after the task guide is closed, user can later browse the task guide activity through the object's history.

This record keeping feature in at least some embodiments of the present invention advantageously ensures that all steps specified in the task guide to be performed accurately. Furthermore, the task guide history enables future troubleshooting and analysis of factory operations, to analyze problems or determine efficiency improvements.

Another aspect of the task guide software component is that it is configured to provide security checks. For instance, the task guide software component may limit which user(s) are allowed to create task guide models, modify created models, launch task guides and/or process launched task guides. In other words, the task guide software component is configured to prevent unauthorized users from using various features thereof.

It should be understood that the various aspects and rules for processing a task guide as discussed in conjunction with FIG. 8 were by way of example, and that the present invention contemplates use with any number of different and/or additional aspects and rules as well.

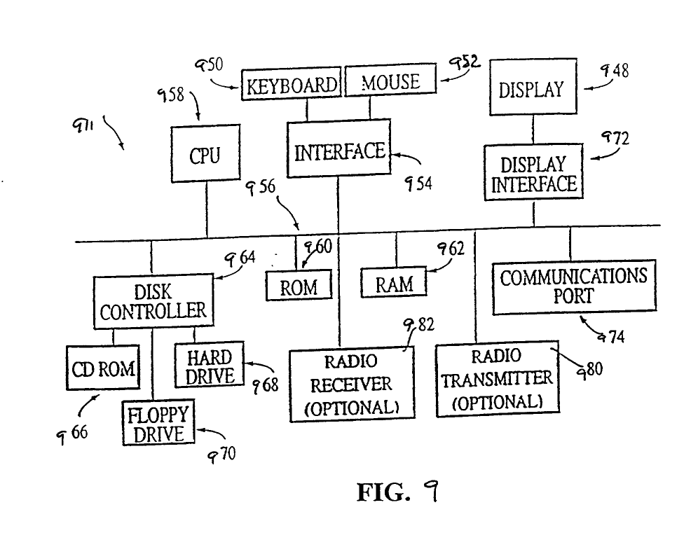

FIG. 9 illustrates a block diagram of one example of the internal hardware of a computer system 911 that can include the task guide software component. A bus 956 serves as the main information highway interconnecting the other components of system 911. CPU 958 is the central processing unit of the system, performing calculations and logic operations required to execute the processes of embodiments of the present invention as well as other programs. Read only memory (ROM) 960 and random access memory (RAM) 962 constitute the main memory of the system. Disk controller 964 interfaces one or more disk drives to the system bus 956. These disk drives are, for example, floppy disk drives 970, or CD ROM or DVD (digital video disks) drives 966, or internal or external hard drives 968. These various disk drives and disk controllers are optional devices.

A display interface 972 interfaces display 948 and permits information from the bus 956 to be displayed on display 948. Display 948 can be used in displaying a graphical user interface generated by GUI server 303. Communications with external devices such as the other components of the system described above can occur utilizing, for example, communication port 974. Optical fibers and/or electrical cables and/or conductors and/or optical communication (e.g., infrared, and the like) and/or wireless communication (e.g., radio frequency (RF), and the like) can be used as the transport medium between the external devices and communication port 974. Peripheral interface 956 interfaces the keyboard 950 and mouse 952, permitting input data to be transmitted to bus 956. In addition to these components, system 911 also optionally includes an infrared transmitter and/or infrared receiver. Infrared transmitters are optionally utilized when the computer system is used in conjunction with one or more of the processing components/stations that transmits/receives data via infrared signal transmission. Instead of utilizing an infrared transmitter or infrared receiver, the computer system may also optionally use a low power radio transmitter 980 and/or a low power radio receiver 982. The low power radio transmitter transmits the signal for reception by components of the production process, and receives signals from the components via the low power radio receiver. The low power radio transmitter and/or receiver are standard devices in industry.

Although system 911 in FIG. 9 is illustrated having a single processor, a single hard disk drive and a single local memory, system 911 is optionally suitably equipped with any multitude or combination of processors or storage devices. For example, system 911 may be replaced by, or combined with, any suitable processing system operative in accordance with the principles of embodiments of the present invention, including sophisticated calculators, and hand-held, laptop/notebook, mini, mainframe and super computers, as well as processing system network combinations of the same.

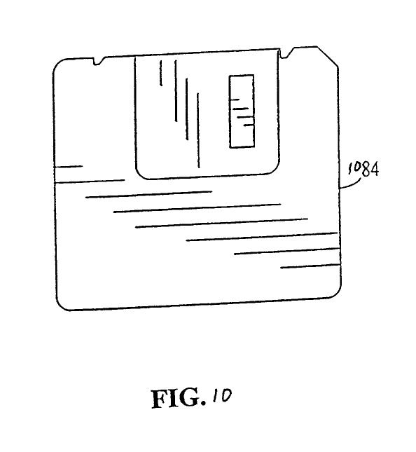

FIG. 10 is an illustration of an exemplary computer readable memory medium 1084 utilizable for storing computer readable code or instructions. As one example, medium 1084 may be used with disk drives illustrated in FIG. 9. Typically, memory media such as floppy disks, or a CD ROM, or a digital video disk will contain, for example, a multi-byte locale for a single byte language and the program information for controlling the above system to enable the computer to perform the functions described herein. Alternatively, ROM 960 and/or RAM 962 illustrated in FIG. 9 can also be used to store the program information that is used to instruct the central processing unit 958 to perform the operations associated with the instant processes. Other examples of suitable computer readable media for storing information include magnetic, electronic, or optical (including holographic) storage, some combination thereof, etc. In addition, at least some embodiments of the present invention contemplate that the medium can be in the form of a transmission (e.g., digital or propagated signals).

In general, it should be emphasized that the various components of embodiments of the present invention can be implemented in hardware, software or a combination thereof. In such embodiments, the various components and steps would be implemented in hardware and/or software to perform the functions of embodiments of the present invention. Any presently available or future developed computer software language and/or hardware components can be employed in such embodiments of the present invention. For example, at least some of the functionality mentioned above could be implemented using Visual Basic, C, C++, or any assembly language appropriate in view of the processor(s) being used. It could also be written in an interpretive environment such as Java and transported to multiple destinations to various users.

The many features and advantages of embodiments of the present invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A task guide system comprising:
a computer having at least one central processing unit;
a computer memory and/or storage, residing within said computer;
a task guide software component, residing at least in part within said computer memory and/or storage, the task guide software component configured to include a plurality of tasks to be performed, including:
one or more tasks that are to be performed optionally; and
one or more mandatory tasks that must be performed,
wherein at least one of the plurality of tasks are performed manually.

2. The system of claim 1, wherein the task guide component is further configured to require that the performance of the plurality of tasks are initiated in a pre-set sequence.

3. The system of claim 2, wherein the task guide component is further configured to include one or more floating tasks that can be initiated out of the pre-set sequence.

4. The system of claim 1, further comprising:
a software object within a software control system, wherein said software object represents or otherwise controls an entity in a manufacturing environment, and wherein said software object is configured to be executed by at least one of the plurality of tasks that are to be performed automatically.

5. The system of claim 4, wherein the software object is configured to trigger a manufacturing machine to run a self diagnostic procedure.

6. The system of claim 4, wherein the software object is configured to cause a material handling system to move a batch of materials from one location to another.

7. The system of claim 1, wherein the plurality of tasks include one or more tasks directed to preventive maintenance of a manufacturing machine.

8. The system of claim 1, wherein the plurality of tasks include one or more tasks directed to a manufacturing process in a microelectronic manufacturing facility.

9. The system of claim 1, wherein the task guide component is configured to be associated with a software object configured to manage a manufacturing machine or a batch of materials to be processed.

10. The system of claim 1, wherein the task guide software component comprises:
a task guide model component that specifies the plurality of tasks; and
a task guide activity component that becomes an instantiated task guide displayed to a user when the task guide model is associated with a software object configured to manage a manufacturing machine or a batch of materials to be processed.

11. The system of claim 1, wherein the plurality of tasks includes a sub-task guide that includes another plurality of tasks.

12. The system of claim 1, wherein the task guide component is further configured to store history information relating to results of performing one or more tasks included in the plurality of tasks.

13. A method of creating and using a computer-implemented task guide, the method comprising the steps of:
entering into the task guide one or more tasks that are to be performed optionally;
entering into the task guide one or more mandatory tasks that are must be performed;
wherein at least one of the one or more entered tasks are performed manually;
displaying said tasks of the task guide entered in said preceding steps; and
initiating at least said mandatory tasks that have been entered in said preceding steps.

14. The method of claim 13, wherein at least one of the steps of entering one or more tasks into the task guide comprises the step of entering a task directed to preventive maintenance of a manufacturing machine.

15. The method of claim 13, wherein at least one of the steps of entering one or more tasks into the task guide comprises the step of entering a task directed to manufacturing process in a microelectronic manufacturing facility.

16. The method of claim 13, further comprising the step of:
sequentially performing the entered one or more tasks.

17. The method of claim 16, further comprising the step of:
entering into the task guide one or more floating tasks that can be performed out of the sequence.

18. The method of claim 13, further comprising the step of:
creating a software object configured to be executed by one or more of the plurality of tasks that are to be performed automatically.

19. The method of claim 18, wherein the step of creating a software object further comprises the step of:
configuring the software object to trigger a manufacturing machine to run a self diagnostic procedure.

20. The method of claim 18, wherein the step of creating a software object further comprises the step of:
configuring the software object to cause a material handling system to move a batch of materials from one location to another.

21. The method of claim 13, further comprising the step of:
associating the task guide with a software object configured to manage a manufacturing machine or a batch of material to be processed.

22. The method of claim 13, further comprising the step of:
creating a task guide model component that specifies the plurality of tasks; and
instantiating the task guide model when the task guide model is associated with a software object configured manage a manufacturing machine or a batch of material to be processed.

23. The method of claim 22, further comprising the step of:
storing a version of the created task guide model.

24. The method of claim 23, further comprising the step of:
preventing an unauthorized user from using various parts of the task guide.

25. The method of claim 13, further comprising the step of:
entering a sub-task guide that includes a plurality of tasks into the one or more of the tasks.

26. The method of claim 13, further comprising the step of:
storing history information relating to results of performing one or more tasks included in the plurality of tasks.

27. The method of claim 13, further comprising the step of:
adjusting task details of at least one of the entered tasks.

28. A computer readable medium comprising instructions for execution by a computer, the instructions instructing the computer to create and use a computer-implemented task guide, the instructions for performing the steps of:
entering into the task guide one or more tasks that are to be performed optionally;
entering into the task guide one or more mandatory tasks that must be performed;
wherein at least one of the one or more entered tasks are performed manually; and
initiating at least said mandatory tasks that have been entered in said preceding steps.

29. The medium of claim 28, further comprising the instructions of:
sequentially performing the entered one or more tasks.

30. The medium of claim 29, further comprising the instructions of:
entering into the task guide one or more floating tasks that are to be performed out of the sequence.

31. The medium of claim 28, further comprising the instructions of:
creating a software object configured to be executed by one or more of the plurality of tasks that are to be performed automatically.

32. The medium of claim 31, further comprising the instructions of:
configuring the software object to trigger a manufacturing machine to run a self diagnostic procedure.

33. The medium of claim 31, further comprising the instructions of:
configuring the software object to cause a material handling method to move a batch of materials from one location to another.

34. The medium of claim 28, wherein at least one of the steps of entering one or more tasks into the task guide comprises the step of entering a task directed to preventive maintenance of a manufacturing machine.

35. The medium of claim 28, wherein at least one of the steps of entering one or more tasks into the task guide comprises the step of entering a task directed to manufacturing process in a microelectronic manufacturing facility.

36. The medium of claim 28, further comprising the instructions of:
associating the task guide with a software object configured manage a manufacturing machine or a batch of material to be processed.

37. The medium of claim 28, further comprising the instructions of:
creating a task guide model component that specifies the plurality of tasks; and
instantiating the task guide model when the task guide model is associated with a software object configured manage a manufacturing machine or a batch of material to be processed.

38. The medium of claim 28, further comprising the instructions of:
entering a sub-task guide that includes a plurality of tasks into the one or more of the tasks.

39. The medium of claim 28, further comprising the instructions of:
storing history information relating to results of performing one or more tasks included in the plurality of task.

40. A task guide system comprising:
a computer having at least one central processing unit;
a computer memory and/or storage, residing within said computer;
a task guide software component, residing at least in part within said computer memory and/or storage, the task guide software component configured to include a plurality of tasks to be performed including:
one or more tasks that are to be performed optionally;
one or more sub-task guide that includes another plurality of tasks; and
one or more mandatory tasks that must be performed,
wherein at least one of the plurality of tasks are performed manually, and at least one of the plurality of tasks are performed automatically,
wherein the plurality of tasks include one or more tasks directed to preventive maintenance of a manufacturing machine or a manufacturing process in a microelectronic manufacturing facility,
wherein the task guide component is further configured to require that the performance of the plurality of tasks are initiated in a pre-set sequence and configured to include one or more floating tasks that can be initiated out of the pre-set sequence, and
wherein the task guide component is further configured to store history information relating to results of performing one or more tasks included in the plurality of tasks; and
a software object within a software control system, wherein said software object represents or otherwise controls an entity in a manufacturing environment, and wherein said software object is configured to be executed by said at least one of the plurality of tasks that are to be performed automatically,
wherein the software object is configured to trigger a manufacturing machine to run a self diagnostic procedure, and
wherein the software object is configured to cause a material handling system to move a batch of materials from one location to another.

41. A task guide system comprising:
a computer having at least one central processing unit;
a computer memory and/or storage, residing within said computer;
a task guide software component, residing at least in part within said computer memory and/or storage, the task guide software component configured to include a plurality of tasks to be performed including:
one or more tasks that are to be performed optionally; and
one or more mandatory tasks that must be performed,
wherein at least one of the plurality of tasks are performed manually,
wherein the task guide component is further configured to require that the performance of the plurality of tasks are initiated in a pre-set sequence and configured to include one or more floating tasks that can be initiated out of the pre-set sequence, and
wherein the task guide component is further configured to store history information relating to results of performing one or more tasks included in the plurality of tasks.

42. A method of creating and using a computer-implemented task guide, the method comprising the steps of:
entering into the task guide one or more tasks that are to be performed optionally;
entering into the task guide one or more mandatory tasks that are must be performed;
entering into the task guide one or more tasks that are to be performed manually;
entering into the task guide one or more tasks that are to be performed automatically;
displaying said tasks of the task guide entered in said preceding steps;
initiating at least said mandatory tasks that have been entered in said preceding steps;
entering into the task guide one or more tasks directed to preventive maintenance of a manufacturing machine;
entering into the task guide one or more tasks directed to manufacturing process in a microelectronic manufacturing facility;
sequentially performing the entered one or more tasks;
entering into the task guide one or more floating tasks that are to be performed out of the sequence;
creating a software object configured to be executed by the one or more of the plurality of tasks that are to be performed automatically;
configuring the software object to trigger a manufacturing machine to run a self diagnostic procedure;
configuring the software object to cause a material handling system to move a batch of materials from one location to another; and
associating the task guide with a software object configured to manage a manufacturing machine or a batch of material to be processed.

43. A method of creating and using a computer-implemented task guide, the method comprising the steps of:
entering into the task guide one or more tasks that are to be performed optionally;
entering into the task guide one or more mandatory tasks that are must be performed, wherein at least one of the one or more entered tasks are performed manually;
displaying said tasks of the task guide entered in said preceding steps;
initiating at least said mandatory tasks that have been entered in said preceding steps;
sequentially performing the entered one or more tasks;
entering into the task guide one or more floating tasks that are to be performed out of the sequence; and
associating the task guide with a software object configured to manage a manufacturing machine or a batch of material to be processed.
